(19) United States
(12) Patent Application Publication
(10) Pub. No.: US 2003/0135745 A1
(43) Pub. Date: Jul. 17, 2003

(54) Method of licensing computer program or data to be used legally

(76) Inventor: Yu-Chin Liu, (US)

Correspondence Address: BRUCE H. TROXELL, 5205 LEESBURG PIKE, SUITE 1404, FALLS CHURCH, VA, 22041, US

(21) Appl. No.: 10/046,970

(22) Filed: Jan. 17, 2002

(51) Int. Cl. H04K 1/00

(52) U.S. Cl. 713/193

(57) ABSTRACT

This invention relates to a method of licensing computer program or data to run or use, and more specifically, using a network transmission protocol to license program or data. This method is to store (embed) register number entered in client side into computer storage, and when the client-side is to execute/use the program or data, the register number is automatically read (fetched) and transmitted to server side through network after encrypting for authorization. Besides identifying the validity, the server also judge whether there are same register numbers to apply for certification at the same time from another client side. If there is not error, the program or data is permitted to execute/use in client side. Otherwise, only partial functions are permitted to use or no functions can be used. So, one method that can ensure program or data to be used legally is provided.

### DESCRIPTION

1. Technical Field

This present invention relates to license computer software or data to be used legally, which includes the steps to apply for authorization by server through network before using computer program or data at client side. After authorization, the program or data can be used legally. The method uses the network effectively to implement the licensing of program or data.

2. Background Art

There are two approaches of licensing computer program (software) or data: licensing during installation and licensing during executing or using the program or data. The approach of licensing during installation is to input legal serial number or register number to complete the installation during installing program or data; otherwise, the installation is forced to quit to prevent being used illegally. The approach of licensing during executing or using is to input serial number or register number during each time to execute the program or access data. The former of two approaches can use the program or data normally once after inputting correct serial number or register number every time, which is efficient to use but easy to be copied illegally. The latter of two approaches is inefficient to operate for inputting serial number or register number during each time to use the program or data, but it is difficult to be used illegally. Therefore, it is a task to acquire the tradeoff between efficiency and legality.

And what's more, there are various changes of authorization approaches according to practical needs. For example, only one copy of program is permitted to be used at one time, but it can be installed on multiple computers, which provides the flexibility of use and data backup. However, for the ability of auditing, it is not consistent for each manufacture. The validity is needed to be authorized. For charging in accordance with use times, the validity is also needed to be authorized. So, one licensing method that can solve above questions is required to fulfill current or later needs.

### OBJECTIVES AND MEANS OF THIS INVENTION

The main objective of this invention is to provide one method for licensing computer program or data to execute/use, which automatically connected to authorization server through network to perform authorization when executing program or using data. After authorization, the program or data at client side can be used normally. This kind of dynamical authorization through network can audit the validity of using program or data.

The second objective of this invention is to provide one method for licensing computer program or data to execute/use, which store the serial number or register number inputted during installation or using the program or data. The stored serial number or register number is sent during network authorization without the inefficiency of inputting the serial number or register number again. This method not only can provide valid auditing, but also has the advantage of efficiency.

The third objective of this invention is to provide one method for licensing computer program or data to execute/use, which permits installing program or data with identical serial number or register number on multiple computers. By the authorization mechanism, only one computer is permitted to execute the program or use the data at the same time, which provides the range of legal using.

The last objective of this invention is to provide one method for licensing computer program or data to execute/use, which uses special encrypting method to encrypt the related information including the above serial number or register number and then transmits it to authorization server to perform authorization. This method has perfect secrecy ability.

### EMBODIMENT

In order to make the honored examiners understand the features and objectives of this invention, several figures are listed below.

The network licensing flowchart of computer program or data of this invention is illustrated as FIG. 8. The left part of FIG. 8 is the flowchart of client side (user side); the right is the flowchart of server side (licensing side). First, as shown in step 11, after “user A” acquired “register number A” and registered in “client-side A” (i.e. computer), the register number A was automatically stored in “client-side A” storage (for example, hard disk). So as shown in step 12, when user A wants to execute this program, the program will fetch the register number A that has been stored in storage and encrypt this register number and other user information to “apply” for licensing at server side, which is shown in step 13. The application is implemented by connecting through network to server side that locates on right part of FIG. 8. As shown in step 14, the server accepts the requests from different client sides after validating the correctness of register numbers, at the same time, the server also checks whether there are concurrent applications with same register numbers. If this situation happens, the latter (the client-side that applies late) cannot be licensed. By this mechanism, only one computer of computers with same register number is permitted to execute the program. After the application of licensing at server side was permitted, the program on client side can execute as formal version, otherwise, only the functions of “trial version” can be executed or the program is forced to quit, which can not acquire the legal using of the program. The steps 16-18 at the bottom of FIG. 8 are network-licensing flowchart of “data usage,” which is similar to that of program. According to features and characteristics of data, the differences are charging information and permitting to use data at one time. If user A needs data like text, music and movie, the encrypted data stored in computer storage will be read; the charging information including the above serial number or register number will be encrypted and then be transmitted to sever side to apply for authorization, which is shown in step 16. In step 17, after the server side received the request, charging is performed according to data charging information, and same data is permitted to be used on different client sides that have different register numbers concurrently. Therefore, as shown in step 18, if the server permits the request, the data then can be used.

The following advantages can be acquired by the measures described above:

Only One Time: As shown in FIG. 1, only one time of registering is required that eliminates the inconvenience and obsession of repeated registering. After user A inputs register number A at client-side A, the register number is automatically stored in storage of client-side A. During each time of executing the program, the register number will be automatically fetched, and then the following authorization activity begins to perform (as shown in FIG. 2). By this licensing mechanism, the inconvenience of repeating to input register number can be eliminated, so one computer program licensing method, which can achieve assured and convenient legally using of program, is provided.

Uniqueness: At one time (concurrently), only the client-side that apply for authorization earliest within all the client-sides that have identical register numbers is permitted to execute computer program. As shown in FIG. 4, if client A and client B has the identical register number A, only one client is permitted to execute the program after being checked by server. So uniqueness is achieved. If the program is needed to execute concurrently on two client-sides, different register numbers are required, as shown in FIG. 3. When client-side A and client-side B has different register number A and B, the programs can be seen to execute independently. In this case, one register number with one computer is the principle. However, according to practical requirement, one register number can be licensed to one or more computers. When it is needed to check the usage of program, only the usage of register number is needed to be checked.

Network: Both client-side and server must connect to network concurrently, and then the network licensing can be implemented. If client-side has not connected to network, network licensing has not the possibility to be performed. By this method, the legality can be validated.

Secrecy: The communication between client-side and server is carried out by using different and special encrypting protocol according to requirements (as shown in FIG. 5). Because the data to be transmitted has been encrypted by special encrypting method, it is unnecessary to worry about being stolen and destroyed easily.

As for the licensing of data, the data is stored in computer storage media after being encrypted particularly (as shown in FIG. 6). When the data is required, besides the steps described above in computer program network licensing, the charging method for the data is also transmitted to server. After being validated, on-line charging is performed and the acknowledgment signal is transmitted back to client-side A. The data will be decrypted by software and then be provided to user A. By this method, charging and checking of the data is performed, and the data is used legally.

It can be shown from the above description that this invention provides one licensing method that applies for authorization through network to server when using computer program or data. By this method, more benefit and more assured effect can be achieved than using traditional static registering method. Accompanying with register number embedding and the features such as uniqueness and secrecy, this method has the advantage of security and convenience. All these features conform to the standards of exclusive law, so the application is presented.

### BRIEF DESCRIPTION OF THE FIGURES

Figure Part

FIG. 1: sketch map of one time licensing activity in this invention

FIG. 2: sketch map of network licensing by using register number in this invention.

FIG. 3: sketch map of different computers using different register numbers in this invention.

FIG. 4: sketch map of different computers using identical register numbers in this invention.

FIG. 5: sketch map of encrypted data in this invention.

FIG. 6: sketch map of data contents in this invention.

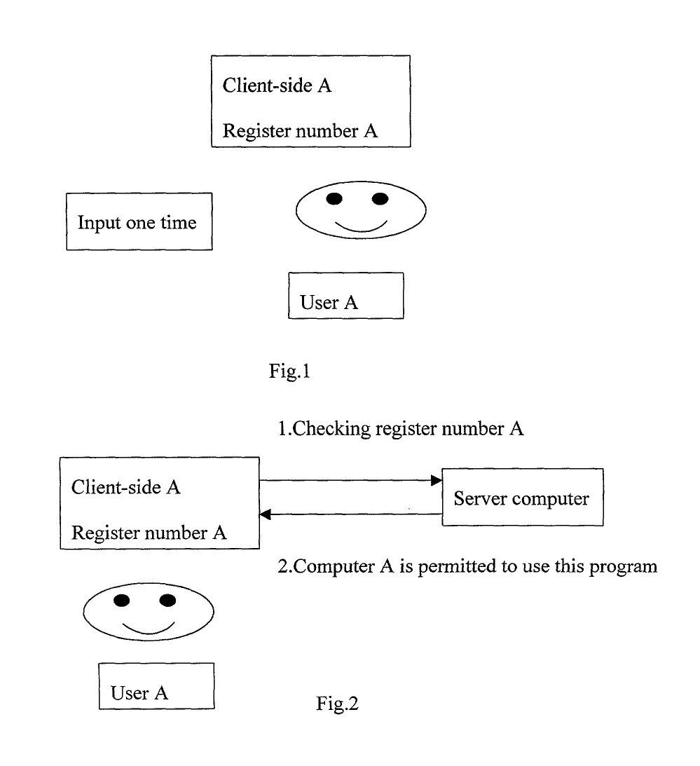

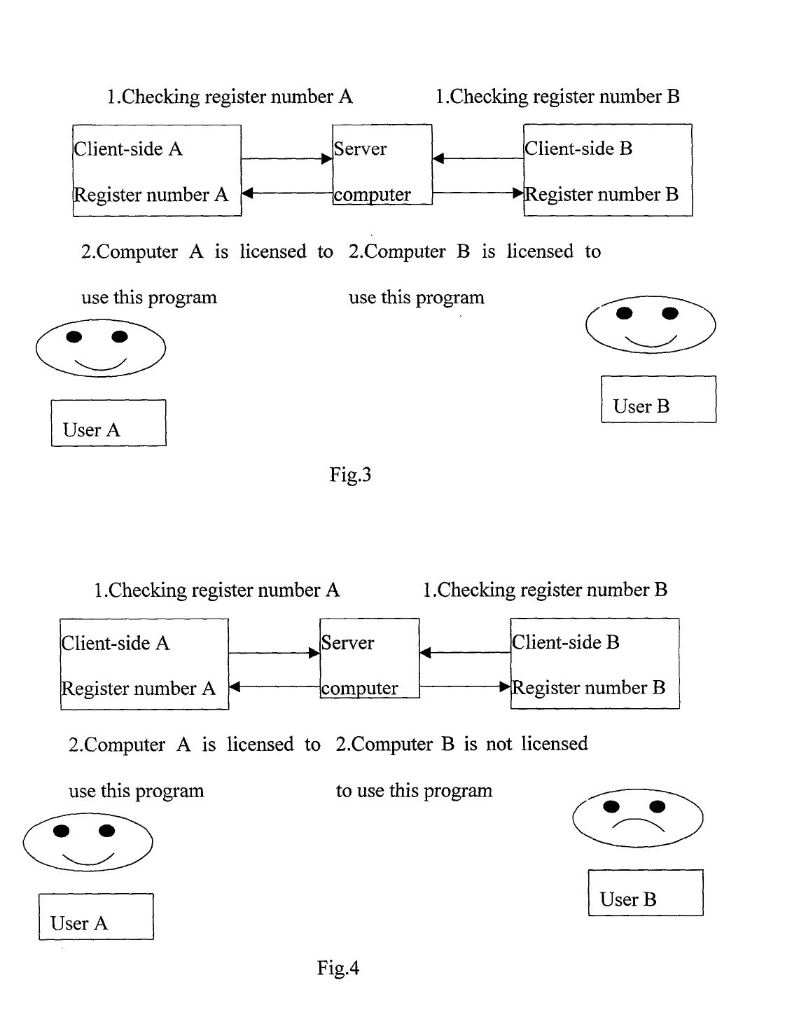

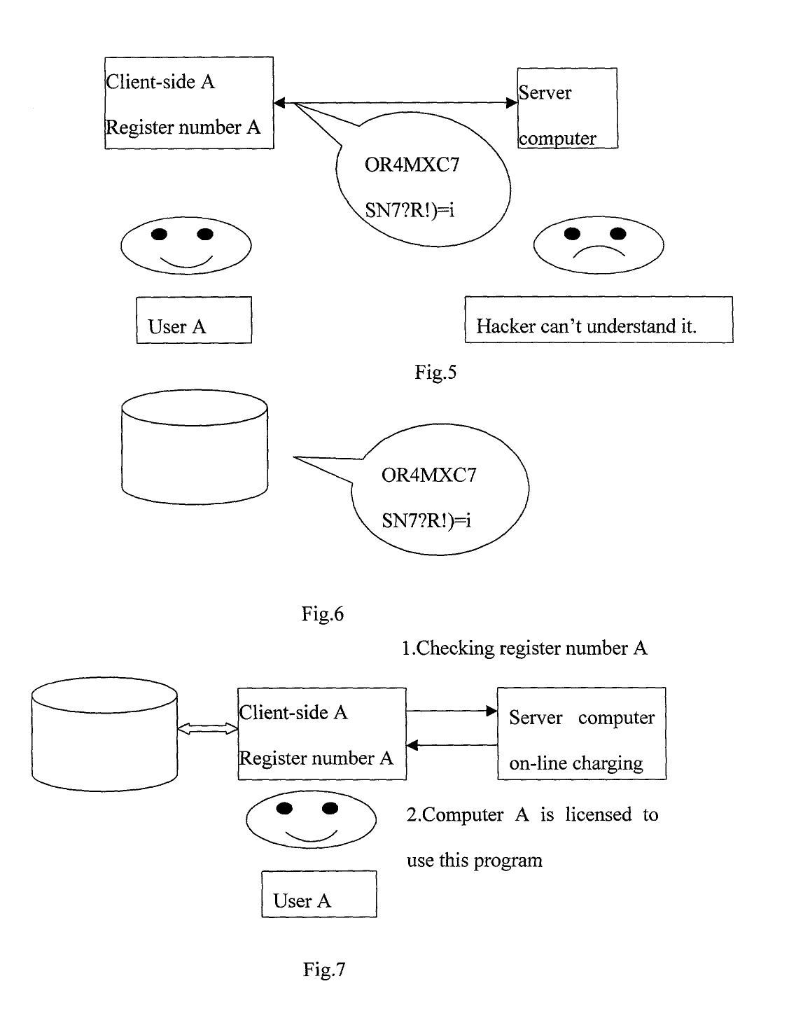

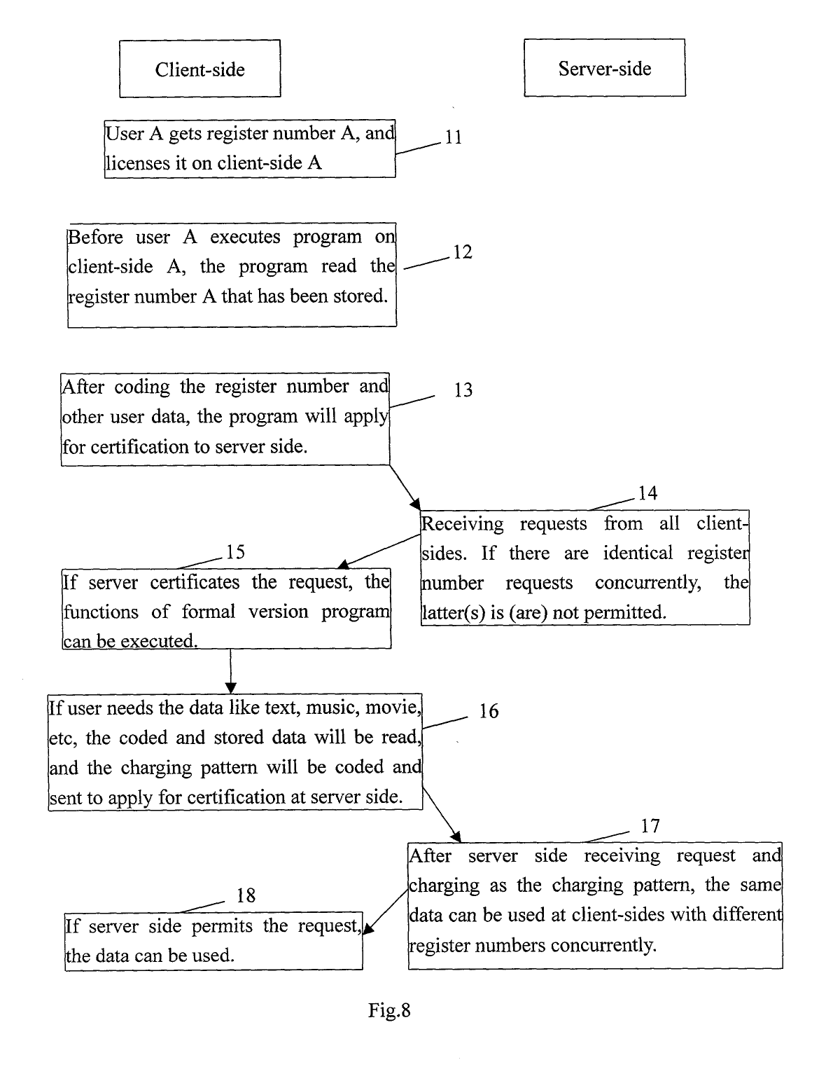

1. A method of licensing program to be used legally, which comprises the steps of:
using register number to licensing the client-side program;
as executing the program, automatically fetching the data of register number and encrypting the data and then transmitting it to server to apply for authorization;
after server accepting above request, checking the legality and the validity of the register number, and then transmitting back the acknowledgment signal to client-side computer;
after client-side receiving licensing signal from server, the program being unlocked and operating normally.

2. The method of claim 1, wherein the register number is embedded in storage of client side.

3. The method of claim 1, wherein communication protocol using special encrypting method is applied between client side and server side.

4. The method of claim 1, wherein server checks the legality and the validity of the received register numbers and whether there are identical register numbers concurrently to apply for authorization;

5. The method of claim 4, wherein if illegal register number (for example: the register number does not exist or is expired) or invalid register number (for example: a “legal” register number is received from a forbidden ip address) is found, the program at client side can be set to forbid the executing of program or only partial function can be executed.

6. The method of claim 4, wherein when identical and valid register numbers are found concurrently and do not exceed the original agreed number of users, authorization is permitted for the client sides to execute the full functions of the programs. Otherwise, authorization is permitted to the earliest request only, and the latter may be forced to quit or only able to execute the function of trial version program.

7. A method of licensing data to be used legally, which comprises the steps of:
encrypting the data that contains some or many of following information: charging information, register number, music, text, and movie, then transmitting the encrypted data to the storage of the user's device (or computer; computer is one type of devices);
when using the data that contains music, text or movie, etc, the client-side program automatically reading the encrypted data, register number and charging information from the storage, after encrypting again, it is transmitted to server to apply for authorization;
after server receiving the above request, checking the legality and the validity of the register number and charging, then transmitting back the acknowledgment signal to client side;
after client-side program receiving the acknowledgment signal from the server, decrypting the required data to the types that can be read or played.

8. The method of claim 7, wherein communication protocol using special encrypting method is applied between client side and server side.

9. The method of claim 7, wherein client sides that have different and valid register numbers can use the same data concurrently. Or if client-sides that have identical and valid register numbers but do not exceed the original agreed users can use the same data concurrently.

10. The method of claim 7, the register number must be stored (or embedded) in the storage of the client side. But the register number is not necessary to be transmitted to user by the same method, or at the same time with the other encoded data.

11. The method of claim 7, the charging procedure (information) can be decided online by the server according to the register number, so the charging information is not necessary to be stored in the storage of client side.
